(19) United States
(12) Patent Application Publication
(10) Pub. No.: US 2026/0331822 A1
(43) Pub. Date: Oct. 22, 2026

(54) POWER CONNECTOR

(71) Applicant: BIZLINK INTERNATIONAL CORP., New Taipei City (TW)

(72) Inventors: Hongping SU, New Taipei City (TW); Haoran ZOU, New Taipei City (TW)

(21) Appl. No.: 19/653,164

(22) Filed: Apr. 21, 2026

(30) Foreign Application Priority Data
Apr. 22, 2025 (CN) 202510511625.2

(51) Int. Cl. H01R 13/533

(52) U.S. Cl. CPC H01R 13/533

(57) ABSTRACT

A power connector including a housing, two terminal modules, two conductive modules, and two power transmission elements. The housing includes a main body defining an accommodation cavity and two protruding portions. The two protruding portions are spaced apart along a first direction to define an insertion slot in communication with the accommodation cavity. Each of the two conductive modules is connected to a respective one of the two terminal modules. Multiple first fins are disposed on a side of one of the two conductive modules. The side is perpendicular to a second direction that is perpendicular to the first direction. The two power transmission elements are partially disposed within the accommodation cavity. Each of the two conductive modules is connected between a respective one of the two terminal modules and a respective one of the two power transmission elements.

### CROSS-REFERENCE TO RELATED APPLICATION

This application claims priority to China Application Serial Number 202510511625.2, filed Apr. 22, 2025, which is herein incorporated by reference in its entirety.

### BACKGROUND

### Field of Invention

The present disclosure relates to a connector. More particularly, the present disclosure relates to a power connector.

### Description of Related Art

Power connectors are typically used at power output terminals. They serve as interface components that transmit electrical power from power modules (such as uninterruptible power supplies, battery banks, and power distribution cabinets) to downstream equipment, and are commonly used to distribute main power to server racks.

Existing power connector has poor heat dissipation capability, which affects their performance.

### SUMMARY

The present disclosure relates to a power connector including a housing, two terminal modules, two conductive modules, and two power transmission elements. The housing includes a main body and two protruding portions extending from a surface of the main body. The main body defines an accommodation cavity. The two protruding portions are spaced apart along a first direction to define an insertion slot in communication with the accommodation cavity. The two terminal modules are disposed within the housing. Each of the two terminal modules extends from the accommodation cavity into a corresponding one of the two protruding portions and is partially exposed within the insertion slot. The two conductive modules are disposed within the accommodation cavity. Each of the two conductive modules is connected to a respective one of the two terminal modules. Multiple fins are disposed on a side of one of the two conductive modules facing toward a side wall of the housing. The two power transmission elements are partially disposed within the accommodation cavity. Each of the two conductive modules is connected between a respective one of the two terminal modules and a respective one of the two power transmission elements.

The technical solution of the present disclosure may improve heat dissipation efficiency by the multiple fins of the two conductive modules and the multiple fins of the two power transmission elements.

It is to be understood that both the foregoing general description and the following detailed description are by examples, and are intended to provide further explanation of the present disclosure as claimed.

### BRIEF DESCRIPTION OF THE DRAWINGS

To illustrate the technical solutions of embodiments of the present disclosure or those of the prior art more clearly, a brief introduction to the drawings used in the description of the embodiments or the prior art is provided below. It is evident that the drawings described below merely represent some embodiments of the present disclosure. A person skilled in the art may, without involving an inventive step, derive other drawings based on the structures shown in these drawings.

FIG. 1 is a schematic view of a structure of a power connector of an embodiment according to the present disclosure;

FIG. 2 is a schematic view of a structure of a housing of an embodiment according to the present disclosure;

FIG. 3 is a schematic view of a structure of the power connector without the housing of an embodiment according to the present disclosure;

FIG. 4 is a schematic view of a structure of a power connector of a further embodiment according to the present disclosure;

FIG. 5 is a cross-section view of the power connector shown in FIG. 4, taken along section line A-A;

FIG. 6 is a cross-section view of the power connector shown in FIG. 1 taken along section line B-B; and

FIG. 7 is a side view of the power connector of an embodiment according to the present disclosure.

The objectives, functional features, and advantages of the present disclosure will be further described with reference to the drawings in conjunction with the embodiments.

### DETAILED DESCRIPTION

The technical solutions of the embodiments of the present disclosure will be described clearly and completely below with reference to the drawings. It should be noted that the embodiments described herein are merely some examples of the present disclosure and do not constitute all possible embodiments. All other embodiments obtained by a person skilled in the art based on the embodiments of the present disclosure, without the need for creative effort, fall within the scope of protection of the present disclosure.

It should be noted that where directional terms (such as up, down, left, right, front, back, etc.) are used in the embodiments of the present disclosure, such terms are intended solely to explain the relative positions and movements of the various components in a specific configuration. If that specific configuration changes, the directional terms will change accordingly.

Furthermore, where the embodiments of the present disclosure include descriptions such as “first” or “second,” such designations are used solely for descriptive purposes and should not be construed as indicating or implying relative importance or as implicitly specifying the number of technical features indicated. Accordingly, features designated as “first” or “second” may explicitly or implicitly include at least one such feature. Furthermore, where the terms “and/or” appear throughout the text, they denote three alternative options. For example, “A and/or B” includes option A, option B, or a combination of both A and B. Furthermore, the technical solutions described in the various embodiments may be combined with one another, provided that such combination is feasible for a person skilled in the art. If the combination of technical solutions results in contradictions or is unfeasible, such combination shall be deemed non-existent and shall not fall within the scope of protection claimed by the present disclosure.

To clearly illustrate the spatial relationship and orientation among components, coordinate axes are shown in the figures: a first axis x, a second axis y, and a third axis z.

Power connectors are typically used at power output terminals. They serve as interface components that transmit electrical power from power modules (such as uninterruptible power supplies, battery banks, and power distribution cabinets) to downstream equipment, and are commonly used to distribute main power to server racks.

Existing power connectors have poor heat dissipation capability, which affects their overall performance.

This present disclosure proposes a power connector designed to improve heat dissipation performance.

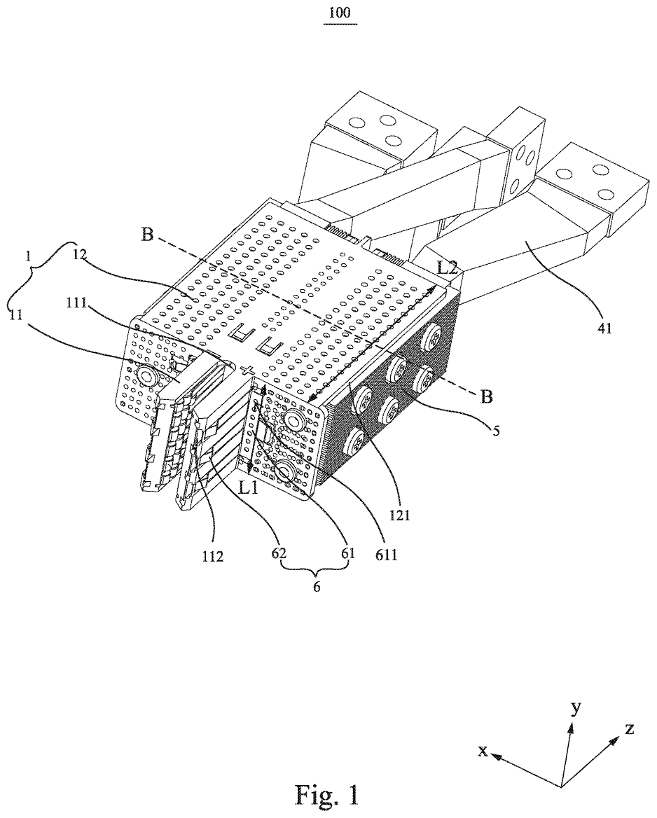

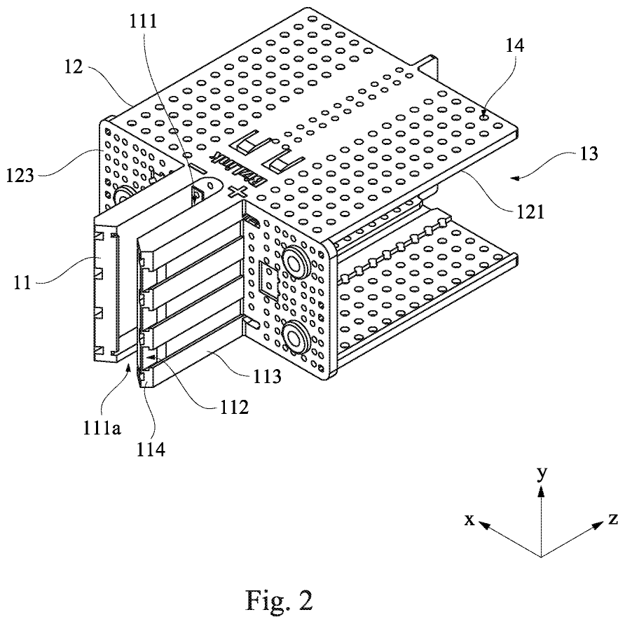

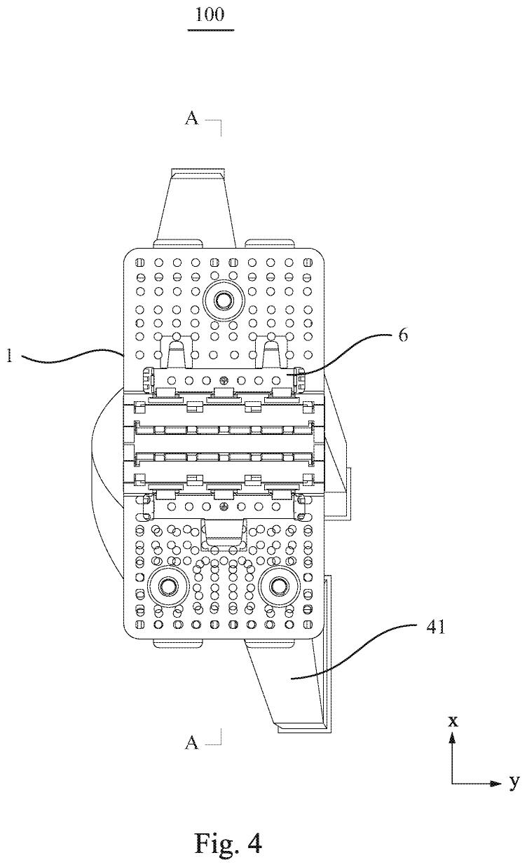

Please refer to FIGS. 1 to 7. In an embodiment of the present disclosure, the power connector 100 includes a housing 1, two terminal modules 2, two conductive modules 3, and two power transmission elements 4. In an embodiment of the present disclosure, the power connector 100 includes at least one heat sink set. The housing 1 includes a main body 12 and two protrusion portions 11 extending from a surface of the main body 12. The main body 12 defines an accommodation cavity 13.

The two protrusion portions 11 are connected to a surface 123 of the main body 12. The two protrusion portions 11 are spaced apart along a first direction (i.e., the first axis x) to define an insertion slot 111 in communication with the accommodation cavity 13.

The two terminal modules 2 are disposed within the housing 1. Each of the two terminal modules 2 extends from the accommodation cavity 13 into a corresponding one of the two protruding portions 11 and is partially exposed within the insertion slot 111.

The two conductive modules 3 are disposed within the accommodation cavity 13. Each of the two conductive modules 3 is connected to a respective one of the two terminal modules 2. Multiple fins are disposed on a side of one of the two conductive modules 3. The side is perpendicular to a second direction (i.e., the second axis y) that is perpendicular to the first direction. Each of the two conductive modules 3 includes two sub-conductive blocks 31. A heat dissipation gap 311 is formed between the two sub-conductive blocks 31. An extended direction of the heat dissipation gap 311 is an insertion direction of the two terminal modules 2. In other words, the extended direction is along a third direction (i.e., the third axis z) that is perpendicular to the first direction and the second direction. The insertion direction is parallel to the third direction.

The two power transmission elements 4 are partially disposed within the accommodation cavity 13. Each of the two power transmission elements 4 is connected to a surface of the two sub-conductive blocks 31 away from the two terminal modules 2. Each of the two conductive modules 3 is connected between a respective one of the two terminal modules 2 and a respective one of the two power transmission elements 4. An end of each of the two power transmission elements 4 is used to connect to a power source.

In some embodiments, each of the two conductive modules 3 has two outer surfaces facing away from each other along the second direction. The multiple of fins are disposed on the two outer surfaces. In some embodiments, each of the two conductive modules 3 is integrally formed with the multiple fins. In other embodiment, each of the two conductive modules 3 has no fin.

In some embodiments, multiple fins are disposed on a surface of one of the two power transmission elements 4 away from the two conductive modules 3. The main body 12 of the housing 1 has a lateral opening 121. The plurality of fins is exposed through the lateral opening 121.

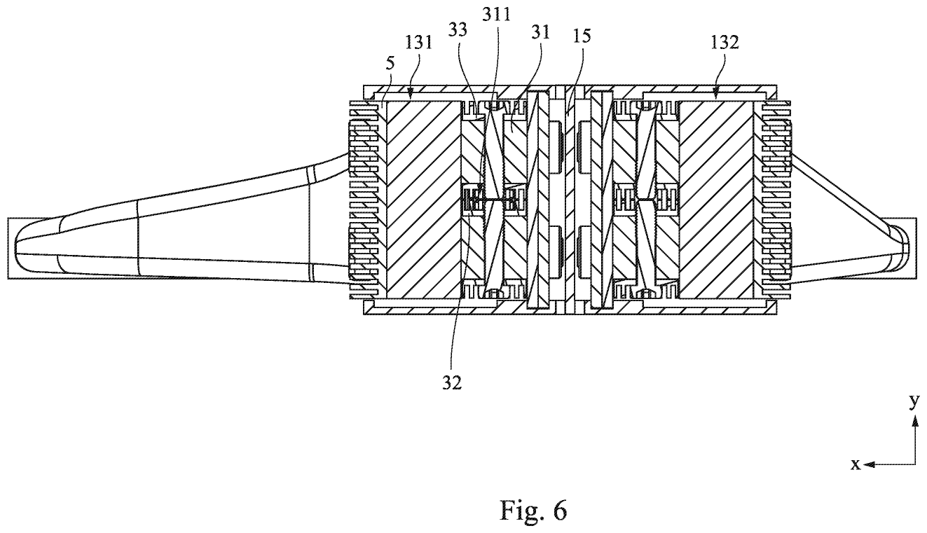

In some embodiments, the accommodation cavity 13 includes a first accommodation cavity 131 and a second accommodation cavity 132. One of the two terminal modules 2, one of the two conductive modules 3, and one of the two power transmission elements 4 are disposed within a respective one of the first accommodation cavity 131 or the second accommodation cavity 132. Specifically, the housing 1 further comprises an insulating component 15 disposed within the accommodation cavity to divide the accommodation cavity into the first accommodation cavity 131 and the second accommodation cavity 132. As shown in FIG. 6, the insulating component 15 is positioned between the components in the first accommodation cavity 131 and the components in the second accommodation cavity 132 along the first direction.

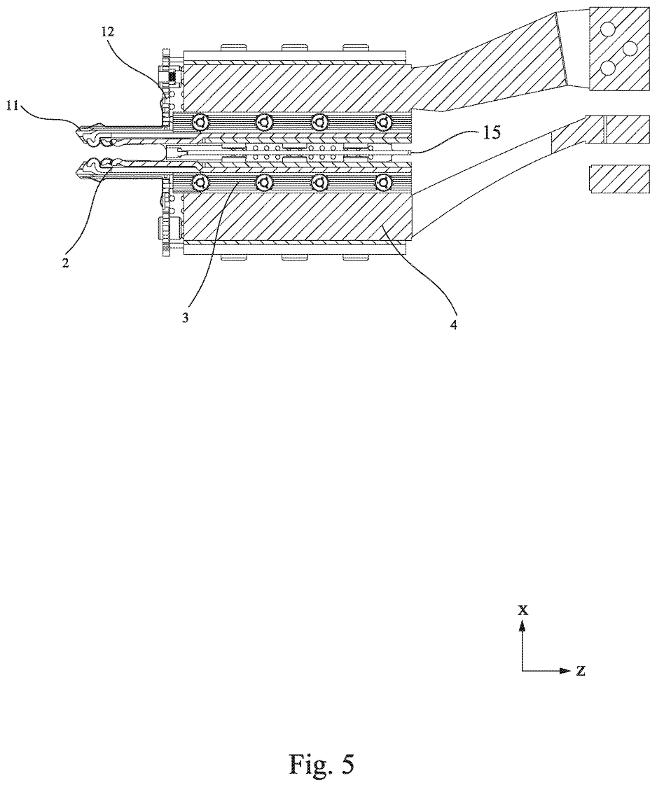

As shown in FIG. 1 and FIG. 5, the insulating component 15 extends along the third direction and protrudes beyond an end of the main body 12 or the surface 123 of the housing 1. This extended portion of the insulating component 15 is positioned between the two terminal modules 2 and serves to physically and electrically isolate the two terminal modules 2 from each other at the insertion interface.

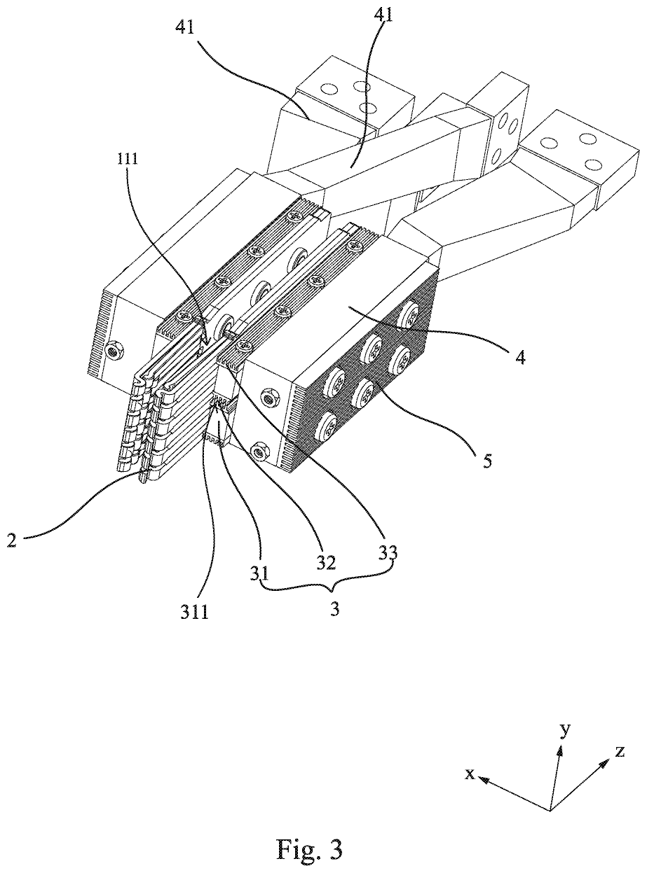

In an embodiment of the present disclosure, the housing 1 and the two terminal modules 2 are made of materials commonly available on the market and are not further specified herein. Each of the two power transmission elements 4 refers to a flexible metal busbar formed by compressing a bundle of copper fibers, such as a flexible copper busbar, or a cable harness including multiple cables. The housing 1 includes the main body 12 and the two protrusion portions 11. The main body 12 is formed with the accommodation cavity 13 for accommodating the two terminal modules 2, two conductive modules 3, and at least a portion of the two power transmission elements 4. The two protrusion portions 11 are disposed on the surface 123 of the main body 12 and are provided with an insertion slot 111 communicating with the accommodation cavity 13. The two terminal modules 2 are inserted into the insertion slot 111. The two protrusion portions 11 are designed to be inserted into a server cabinet, thereby establishing an electrical connection between the two terminal modules 2 and the cabinet busbar. In an embodiment of the present disclosure, the two protrusion portions 11 are integrally formed with the main body 12, enhancing the overall connection strength of the housing 1. The two terminal modules 2, the two conductive modules 3, and the two power transmission elements 4 located on the same side are connected together using bolts or screws. Each of the two conductive modules 3 includes the two sub-conductive blocks 31. The two sub-conductive blocks 31 are arranged along the second direction (i.e., the second axis y). Consequently, the heat dissipation gap 311 formed between the two sub-conductive blocks 31 extends along the longitudinal direction of the two terminal modules 2 (i.e., the third direction/the third axis z). This results in a longer heat dissipation gap, correspondingly increasing the heat dissipation area and improving the heat dissipation performance of the power connector 100. It should be understood that, in another embodiment of the present disclosure, the two sub-conductive blocks 31 are arranged in a width direction of the two terminal modules 2 (i.e., perpendicular to the direction of arrangement of the two terminal modules 2 and the two power transmission elements 4). The heat dissipation gap 311 formed between the two sub-conductive blocks 31 is also arranged in the width direction of the terminal module 2. The direction from the end of the two terminal modules 2 exposed in insertion slot 111 to the end located within the main body 12 of housing 1 is the longitudinal direction of terminal module 2 (i.e., the insertion direction of the two terminal modules 2) (i.e., the third direction). The direction of a thickness direction of housing 1 (i.e., the left-right direction shown in FIG. 3) is the width direction of terminal module 2 (i.e., perpendicular to the direction of arrangement of the two terminal modules 2 and the two power transmission elements 4) (i.e., the first direction).

The technical solution of the present disclosure employs the two conductive modules 3 that each of the two conductive modules 3 including two separately arranged sub-conductive blocks 31. The heat dissipation gap 311 is formed between the two sub-conductive blocks 31, with the heat dissipation gap 311 extending in the same direction as an insertion direction of the two conductive modules 3. Air can flow through the heat dissipation gap 311 between the two sub-conductive blocks 31, dissipating the heat generated by the sub-conductive blocks 31 and other parts of the power connector 100, thereby enhancing the heat dissipation performance of the power connector 100.

In an embodiment of the present disclosure, a first heat sink set 32 is disposed between the two sub-conductive blocks 31.

In an embodiment of the present disclosure, a second heat sink set 33 is disposed on a surface of one of the two sub-conductive blocks 31 away from another of the two sub-conductive blocks 31.

In an embodiment of the present disclosure, a third heat sink set 5 is disposed on a surface of the two power transmission elements 4 away from the two conductive modules 3.

In an embodiment of the present disclosure, to further improve the heat dissipation performance of the power connector 100, the first heat sink set 32 is disposed between the two sub-conductive blocks 31. In other words, the first heat sink set 32 is disposed within the heat dissipation gap 311. The first heat sink set 32 is made of aluminum, which has a high specific heat capacity, or copper, which has a high thermal conductivity. The first heat sink set 32 includes multiple fins spaced apart from one another, which serve to increase the surface area of the first heat sink set 32, improve heat dissipation efficiency, and thereby enhance the heat dissipation performance of the power connector 100.

In an embodiment of the present disclosure, the second heat sink set 33 is disposed on an outer surface of each of the two sub-conductive blocks 31. That is, the second heat sink set 33 is disposed on the surface of one of the two sub-conductive blocks 31 away from another of the two sub-conductive blocks 31. The second heat sink set 33 is made of aluminum, which has a high specific heat capacity, or copper, which has a high thermal conductivity. The second heat sink set 33 includes multiple fins spaced apart from one another, which serve to increase the surface area of the second heat sink set 33, improve heat dissipation efficiency, and thereby enhance the heat dissipation performance of the power connector 100.

In an embodiment of the present disclosure, the second heat sink set 33, the two sub-conductive blocks 31, and the first heat sink set 32 located on the same side are connected into a single unit via bolts or screws. In an embodiment of the present disclosure, there are two of the second heat sink sets 33, the two sub-conductive blocks 31, and two of the first heat sink sets 32 between one of the two terminal modules 2 and one of the two power transmission elements 4 (i.e., those elements are located on the same side). It should be understood that the six components—the two of the second heat sink sets 33, the two sub-conductive blocks 31, and the two of the first heat sink set 32—located on the same side are connected into a single unit via bolts or screws.

To further enhance the heat dissipation performance of power connector 100, a third heat sink set 5 is disposed on a surface of one of the two power transmission elements 4 away from the two conductive modules 3. The third heat sink set 5 is made of aluminum, which has a high specific heat capacity, or copper, which has a high thermal conductivity. The third heat sink set 5 includes multiple fins spaced apart from one another, which serve to increase the surface area of the third heat sink set 5, improve heat dissipation efficiency, and thereby enhance the heat dissipation performance of the power connector 100. It should be understood that the four components—one of the two terminal modules 2, one of the two conductive modules 3, one end of one of the two power transmission elements 4, and the third heat sink set 5—located on the same side are connected into a single unit via screws or bolts.

The stacking direction of the one of the two terminal modules 2, the one of the two conductive modules 3 (i.e., including the two sub-conductive blocks 31), the one of the two power transmission elements 4, and the third heat sink set 5 is the width direction of the housing 1 (i.e., perpendicular to the direction of arrangement of the two terminal modules 2 and the two power transmission elements 4).

In an embodiment of the present disclosure, one of the two sub-conductive blocks 31 is integrally formed with at least one of the first heat sink set 32 and the second heat sink set 33.

In an embodiment of the present disclosure, the first heat sink set 32 is machined on the surface of one of the two sub-conductive blocks 31 facing another of the two sub-conductive blocks 31, so that the one of the two sub-conductive blocks 31 and the first heat sink set 32 are integrally formed without the need for connection, thereby enhancing the overall structural strength. The surface of the one of the two sub-conductive blocks 31 away from the another of the two sub-conductive blocks 31 may also be machined to form the second heat sink set 33, so that the one of the two sub-conductive blocks 31 and the second heat sink set 33 are integrally formed without the need for additional connecting elements, thereby enhancing the overall structural strength.

In an embodiment of the present disclosure, a gap is formed between the first heat sink set 32 and the two sub-conductive blocks 31.

Alternatively, the first heat sink set 32 is connected to the surface of one of the two sub-conductive blocks 31 facing to another of the two sub-conductive blocks 31.

In an embodiment of the present disclosure, a gap is formed between the first heat sink set 32 and the two sub-conductive blocks 31, allowing air to flow through the gap. While actively dissipating heat through the first heat sink set 32, heat from the first heat sink set 32 is also carried away by the airflow within the gap, thereby enhancing the heat dissipation effect. It should be understood that, in another embodiment of the present disclosure, the first heat sink set 32 is directly connected to the surface of one of the two sub-conductive blocks 31 without the need for additional connecting components, thereby improving the overall structural strength.

In one embodiment, each of the two conductive modules 3 is a unitary structure. The plurality of fins are integrally formed on two opposite side surfaces of each conductive module 3. Since one of the two conductive modules 3 and the fins are formed as a single piece, no bolts, screws, or other fasteners are required to secure the fins to the conductive module 3. This integrated design reduces contact thermal resistance and enhances the overall structural strength.

In the embodiments of the present disclosure, the main body 12 of the housing 1 is disposed with the lateral opening 121, through which the third heat sink set 5 is exposed.

In the embodiments of the present disclosure, the main body 12 of the housing 1 has the lateral opening 121 to allow the third heat sink set 5 to be exposed through the lateral opening 121, enabling heat from the third heat sink set 5 to dissipate through the lateral opening 121 and thereby improving the heat dissipation performance of the power connector 100.

In the embodiments of the present disclosure, the thickness of housing 1 is in a range from 32 mm to 40 mm. In other words, the range of the thickness of housing 1 may more than 32 mm and less than 40 mm. A length L1 of one of the two protrusion portions 11 along the second direction is in a range of 37.35 mm to 39.55 mm. In some embodiments, the length L1 is equal to or less than 43 mm. A length L2 of the housing 1 along a third direction is in a range of 63 mm to 73.19 mm.

The housing 1 has a plurality of heat dissipation holes 14 communicating with the accommodation cavity 13.

In the embodiments of the present disclosure, as shown in FIG. 3, the left-to-right direction in FIG. 3 corresponds to the thickness direction of the housing 1. The thickness of the housing 1 is in the ranges from 32 mm to 40 mm, such as 32 mm, 33 mm, 34 mm, 35 mm, 36 mm, 37 mm, 38 mm, 39 mm, 40 mm, or any value within this range. The thickness of housing 1 should not be too small, as an excessively thin housing 1 would result in the two terminal modules 2 and the two conductive modules 3 being too narrow to carry large currents. The thickness of housing 1 should not be too large, as an excessively thick housing 1 would prevent the entire power connector 100 from fitting into a server cabinet.

In the embodiments of the present disclosure, housing 1 has multiple heat dissipation holes 14, which are evenly spaced across housing 1. The heat dissipation holes 14 allows heat generated by the two terminal modules 2, the two conductive modules 3, and the two power transmission elements 4 within housing 1 to dissipate through the heat dissipation holes 14 to the exterior of housing 1, thereby improving the heat dissipation performance of power connector 100.

In an embodiment of the present disclosure, the power connector 100 further includes a grounding terminal 6. The grounding terminal 6 includes a base 61 and a terminal portion 62. The base 61 and the terminal portion 62 are integrally formed. The base 61 is embedded in the surface 123 of the main body 12, and the terminal portion 62 is embedded in an outer wall 113 of one of the two protrusion portions 11 away from the insertion slot 111. The base 61 has a plurality of through holes 611. One of the through holes 611 communicates with one of the heat dissipation holes 14. The grounding terminal 6 is used for ground connection.

The protruding portion 11 has a vent hole 112 disposed on an end face 114 of the protruding portion 11 away from the main body 12. The vent hole 112 communicates with the insertion slot 111 and the accommodation cavity 13.

In an embodiment of the present disclosure, the terminal portion 62 of the grounding terminal 6 is embedded in the outer wall 113 of the one of the two protrusion portions 11 away from the insertion slot 111. The grounding terminal 6 further includes a base 61 integrally formed with the terminal portion 62. The base 61 is embedded in the surface 123 of the main body 12, and the base 61 is provided with multiple through holes 611. One of the through holes 611 communicates with the heat dissipation holes 14 on the main body 12 to allow air to circulate between the interior and exterior. The grounding terminal 6 is used for grounding connections to prevent damage to the power connector 100, prevent fires, protect against lightning strikes, prevent electrostatic damage, and ensure the normal operation of the power system.

The vent hole 112 is formed at the end of one of the two protrusion portions 11 away from the main body 12. The vent hole 112 communicates with the accommodation cavity 13 via the insertion slot 111, allowing heat generated by the two terminal modules 2, the two conductive modules 3, and the two power transmission elements 4 within the accommodation cavity 13 to be discharged from the housing 1 through the insertion slot 111 and ultimately via the heat dissipation holes 14, thereby enhancing the heat dissipation performance of the power connector 100.

In an embodiment of the present disclosure, there are multiple terminal portions 62 of the grounding terminal 6, and the multiple terminal portions 62 are spaced apart and embedded on the outer wall 113 of one of the two protrusion portions 11 away from the insertion slot 111.

In an embodiment of the present disclosure, the number of the vent hole 112 is multiple. One of the vent holes 112 is between two of the terminal portions 62.

In an embodiment of the present disclosure, the terminal portions 62 are spaced apart and embedded on the outer wall 113 of one of the two protrusion portions 11 away from the insertion slot 111, further preventing damage to power connector 100, preventing fires and lightning strikes, preventing electrostatic damage, and ensuring the normal operation of the power system.

Accordingly, the number of the vent hole 112 is multiple. One of the vent holes 112 is positioned between two of the terminal portions 62. The vent holes 112 communicate with the accommodation cavity 13 via the insertion slot 111, allowing the heat generated by the two terminal modules 2, the two conductive modules 3, and the two power transmission elements 4 within the accommodation cavity 13 to be discharged through the insertion slot 111 and ultimately out of the housing 1 via the heat dissipation holes 14, further enhancing the heat dissipation performance of the power connector 100.

In an embodiment of the present disclosure, one of the two power transmission elements 4 branches into two sub-power transmission elements 41 at an end away from the protruding portion 11. Soldering surfaces of the two sub-power transmission elements 41 are perpendicular to each other.

In an embodiment of the present disclosure, the end (away from the protruding portion 11) of one of the two power transmission elements 4 branches to form the two sub-power transmission elements 41. The soldering surfaces of the two sub-power transmission elements 41 located on the same side are perpendicular to each other. The two sub-power transmission elements 41 with soldering surfaces perpendicular to each other on opposite sides are connected to a connector to establish an electrical connection with an external power source.

The present disclosure further proposes a power connector 100 including a housing 1, two terminal modules 2, two conductive modules 3, and two power transmission elements 4. In an embodiment of the present disclosure, the power connector 100 includes at least one heat sink set. The housing 1 includes a main body 12 and a protrusion portion 11. The main body 12 has an accommodation cavity 13. The protrusion portion 11 is connected to a surface 123 of the main body 12. The protrusion portion 11 has an insertion slot 111. An end of the insertion slot 111 communicates with the accommodation cavity 13. The two terminal modules 2 pass through the protrusion portion 11 and are exposed at an opening 111a of the insertion slot 111. The two conductive modules 3 are disposed within the accommodation cavity 13. One of the two conductive modules 3 is connected to a surface of one of the two terminal modules 2 away from another of the two terminal modules 2. The power connector 100 has heat sink sets. Opposite sides of the two conductive modules 3 adjacent to the two terminal modules 2 have two of the heat sink sets. An end of each of the two power transmission elements 4 is positioned within the accommodation cavity 13 and is connected to a surface of one of the two conductive modules 3 away from the two terminal modules 2. The other end of each of the two power transmission elements 4 is used to connect to a power source. A surface of each of the two power transmission elements 4 away from the two conductive modules 3 has one of the heat sink sets.

In an embodiment of the present disclosure, the housing 1, the two terminal modules 2, and the two power transmission elements 4 are made of materials commonly available on the market and are not further specified herein. The housing 1 includes a main body 12 and a protrusion portion 11. The main body 12 has an accommodation cavity 13 for accommodating the two terminal modules 2, the two conductive modules 3 and at least one portion of the two power transmission elements 4. The protrusion portion 11 is disposed on a surface 123 of the main body 12. The protrusion portion 11 has an insertion slot 111 communicating with the accommodation cavity 13. The two terminal modules 2 are inserted into the insertion slot 111. The protrusion portion 11 is configured to be inserted into a server cabinet, thereby electrically connecting the two terminal modules 2 to the cabinet busbar. In an embodiment of the present disclosure, the protrusion portion 11 is integrally formed with the main body 12, enhancing the overall connection strength of the housing 1. The two terminal modules 2, the two conductive modules 3, and the two power transmission elements 4 located on the same side are connected together via bolts or screws. Two outer surfaces of one of the two conductive modules 3 adjacent to the two terminal modules 2 have heat sink sets. Each of the heat sink set is made of aluminum, which has a high specific heat capacity, or copper, which has a high thermal conductivity. The heat sink set includes multiple spaced apart fins to increase the surface area of the assembly, improve heat dissipation efficiency, and thereby enhance the heat dissipation performance of the power connector 100.

To further enhance the heat dissipation performance of the power connector 100, the heat sink set is provided on the surface of the power transmission element 4 away from the surface of the conductive module 3. The heat sink set is made of aluminum, which has a high specific heat capacity, or copper, which has a high thermal conductivity. The heat sink set includes multiple spaced apart fins to increase the surface area of the assembly, improve heat dissipation efficiency, and thereby enhance the heat dissipation performance of the power connector 100. It should be understood that those components—one of the two terminal modules 2, one of the two conductive modules 3, the end of one of the two power transmission elements 4, the heat sink set disposed on the outer surface of one of the two conductive modules 3, and the heat sink set disposed on the surface of one of the two power transmission elements 4—located on the same side are connected into a single unit using screws or bolts.

In some embodiments, the plurality of fins are disposed on opposite sides of one of the two conductive modules 3. The opposite sides are arranged along the second direction (i.e., the second axis y) perpendicular to the first direction (i.e., the first axis x). A plurality of fins are disposed on a surface of one of the two power transmission elements 4 away from the two conductive modules 3.

In the embodiment of FIG. 6, each of the second heat sink set 33, the two power transmission elements 4, and the third heat sink set 5 has two outer surfaces along the second direction (i.e., the second axis y). One of the two outer surfaces of the second heat sink set 33, each of the two power transmission elements 4, and the third heat sink set 5 are coplanar. In other words, one of the two outer surfaces of the second heat sink set 33, each of the two power transmission elements 4, and the third heat sink set 5 are in the same plane. The plane is parallel to the first direction (i.e., the first axis x).

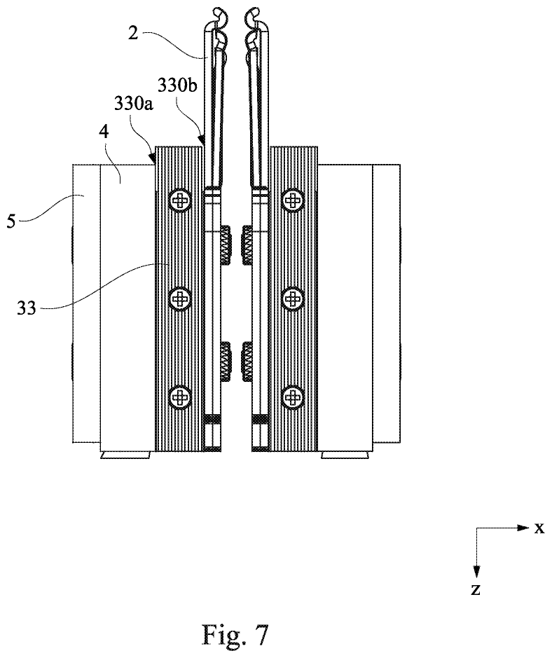

In the embodiment of FIG. 7, at a position proximate to the front ends of the two terminal modules 2 near the insertion slot 111, a gap 330a is between a side of an end of the second heat sink set 33 and one of the two power transmission elements 4. A gap 330b is between another side of the end of the second heat sink set 33 and one of the two terminal modules 2.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

What is claimed is:

1. A power connector, comprising:
a housing comprising a main body and two protruding portions extending from a surface of the main body, the main body defining an accommodation cavity, and the two protruding portions being spaced apart along a first direction to define an insertion slot in communication with the accommodation cavity;
two terminal modules disposed within the housing, each of the two terminal modules extending from the accommodation cavity into a corresponding one of the two protruding portions and being partially exposed within the insertion slot;
two conductive modules disposed within the accommodation cavity, each of the two conductive modules being connected to a respective one of the two terminal modules, wherein a plurality of first fins are disposed on a side of one of the two conductive modules facing toward a side wall of the housing;
two power transmission elements partially disposed within the accommodation cavity;
wherein each of the two conductive modules is connected between a respective one of the two terminal modules and a respective one of the two power transmission elements.

2. The power connector of claim 1, wherein each of the two conductive modules has two outer surfaces facing away from each other along a second direction perpendicular to the first direction, and the plurality of first fins are disposed on the two outer surfaces.

3. The power connector of claim 2, wherein each of the two conductive modules is integrally formed with the plurality of first fins.

4. The power connector of claim 1, wherein each of the two conductive modules comprises two sub-conductive blocks, a heat dissipation gap is defined between the two sub-conductive blocks and extends along a third direction perpendicular to the first direction.

5. The power connector of claim 4, wherein each of the two sub-conductive blocks comprises an inner surface, the inner surfaces of the two sub-conductive blocks face each other, a plurality of second fins are formed on the inner surfaces, and the heat dissipation gap is defined by the plurality of second fins of the two sub-conductive blocks.

6. The power connector of claim 4, wherein a heat sink set is disposed between the sub-conductive blocks, the heat sink set comprises a plurality of second fins, and the heat dissipation gap is defined within the heat sink set.

7. The power connector of claim 1, wherein a plurality of second fins are disposed on a surface of one of the two power transmission elements away from the two conductive modules, the main body of the housing has a lateral opening, and the plurality of second fins is exposed through the lateral opening.

8. The power connector of claim 1, wherein a heat sink set comprises the plurality of first fins and is disposed on two outer surfaces of the two conductive modules facing away from each other along a second direction perpendicular to the first direction.

9. The power connector of claim 7, wherein a heat sink set is disposed on the surface of one of the two power transmission elements, the heat sink set comprises the plurality of second fins.

10. The power connector of claim 1, wherein the accommodation cavity comprises a first accommodation cavity and a second accommodation cavity, one of the two terminal modules, one of the two conductive modules, and one of the two power transmission elements are disposed within a respective one of the first accommodation cavity or the second accommodation cavity.

11. The power connector of claim 2, wherein a thickness of the housing is more than 32 mm and less than 40 mm, a length of one of the two protrusion portions along the second direction is in a range of 37.35 mm to 39.55 mm, and a length of the housing along a third direction is in a range of 63 mm to 73.19 mm.

12. The power connector of claim 1, wherein the housing has a plurality of heat dissipation holes communicating with the accommodation cavity.

13. The power connector of claim 12, wherein the power connector further comprises a grounding terminal, the grounding terminal comprises a base and a terminal portion, the base and the terminal portion are integrally formed, the base is embedded in a surface of the main body of the housing, the terminal portion is embedded in an outer wall of the protrusion portion away from the slot, and the grounding terminal is configured for grounding connection.

14. The power connector of claim 13, wherein the base has a plurality of through holes, one of the plurality of through holes communicates with one of the plurality of heat dissipation holes.

15. The power connector of claim 13, wherein one of the two protruding portions has a vent hole disposed on an end face of the one of the two protruding portions away from the main body, and the vent hole communicates with the slot and the accommodation cavity.

16. The power connector of claim 15, wherein the grounding terminal comprises a plurality of terminal portions, the plurality of terminal portions are spaced apart and embedded in the outer wall of the protrusion portion away from the slot.

17. The power connector of claim 16, wherein one of the two protruding portions has a plurality of vent holes, and one of the plurality of vent holes is located between two of the plurality of terminal portions.

18. The power connector of claim 1, wherein one of the two power transmission elements branches into two sub-power transmission elements at an end away from the two protruding portions.

19. The power connector of claim 18, wherein soldering surfaces of the two sub-power transmission elements are perpendicular to each other.

20. The power connector of claim 1, wherein the plurality of first fins are disposed on opposite sides of one of the two conductive modules, the opposite sides are arranged along a second direction perpendicular to the first direction, and a plurality of second fins are disposed on a surface of one of the two power transmission elements away from the two conductive modules.
